(19) United States
(12) Patent Application Publication
(10) Pub. No.: US 2018/0362221 A1
(43) Pub. Date: Dec. 20, 2018

(54) Insulated Container

(71) Applicant: Be Bottle Company, LLC, West Caldwell, NJ (US)

(72) Inventor: Simon Hooks, Chester, NJ (US)

(21) Appl. No.: 15/626,141

(22) Filed: Jun. 18, 2017

(51) Int. Cl. B65D 41/04; B65D 51/24; B65D 81/18; B65D 81/38; B65D 41/28; A47J 41/02; B01D 35/30

(52) U.S. Cl. CPC B65D 41/04; B65D 51/242; B65D 81/18; B01D 35/30; B65D 41/28; A47J 41/028; B65D 81/3841

(57) ABSTRACT

A container is defined as having a body with by a cylindrical sidewall and preferably formed from stainless steel. The body includes an inside wall, an outside wall, and first and second open ends. The inside and outside walls are spaced from one another to define an insulation space within the sidewall. A bottom cap is removably attachable to and closes the first end of the sidewall. A top cap is removably attachable to and closes the second end of the sidewall. The bottom cap and top cap combine with the sidewall to create an interior storage volume. Both ends of the sidewall may serve as a dispensing opening for the container by proper positioning of and removal of the respective cap.

### FIELD OF THE INVENTION

The present disclosure relates to a container having insulated sidewalls and both a removable top cap and bottom cap. The container preferably forms a liquid storage and dispensing bottle.

### BACKGROUND OF THE INVENTION

A consumer often desires to travel with beverages, food products or other materials from one location to another. Often the material stored in the container is desired to be maintained within a temperature range either above or below ambient temperature. An insulating feature is sometimes added to such containers. The insulating function may be accomplished in any number of ways, depending on the shape and material of the container.

There has be a trend to form insulated beverage containers from rugged materials, such as stainless steal, aluminum, or rigid plastic. The insulating feature in these bottles is sometimes created by a double-walled structure that is vacuum-sealed. The double-walled structure includes a minimum number of physical connections, limiting thermal transfer by conductivity. Alternately, an insulating material may be added inside the bottle structure. An example of an insulated stainless steel bottle structure is shown in US 2013/0032564 A1 to Rosbach. One method of making a metallic double-walled container is shown in U.S. Pat. No. 5,588,197 to Satomi et al.

In addition to insulation to maintain desired temperature range, devices may be included as part of the container structure that serve to increase the hot or cold temperature. For example, US 2014/0284342 A1 to Hewitt et al. shows a base structure have a sealed chamber therein. The chamber retains a fluid that can be frozen and serves to help maintain the cold or cool temperature of the stored material. Similar structures are known for retaining a heated fluid to maintain the hot or warm temperature of the material to be retained.

Other structures are known to be included as part of insulated containers, including insulated caps; see, for example, US 2016/0318693 A1 to Hein et al.

### SUMMARY OF THE INVENTION

The present disclosure relates to a container preferably having a body with by a cylindrical sidewall and formed from stainless steel. The body includes an inside wall, an outside wall, and first and second open ends. The inside surface of the inside wall defines an hollow interior for the container. The inside and outside walls are spaced from one another to define a spaced volume. A bottom cap is removably attachable to and closes the first end of the sidewall. A top cap is removably attachable to and closes the second end of the sidewall. The bottom cap and top cap combine with the sidewall to close the hollow interior and to create an interior storage volume. Both ends of the sidewall may serve as a dispensing opening for the container by proper positioning of and removal of the respective cap. The inside and outside walls are preferably attached to one another to seal the internal volume. A vacuum may be provided upon attaching the walls together to assist in creating the insulating function.

The contemplated container may be further defined by the body sidewall being formed about the central longitudinal axis, with the inside and outside walls concentrically formed about the axis. The inside and outside walls may be affixed to one another adjacent both the first and second ends. The top cap and bottom cap may be dimensioned to match the outside dimensions of the outside wall and to create an integrated appearance.

The container may further include a pivotable handle attached to the top cap. The handle may be recessed into the top wall of the cap. Further the handle may be resiliently fixed into an upward pivoted position and in the downward pivoted, recessed position.

The container may further include a tapered wall at the top end of the sidewall and a dispensing opening at the narrow end of the tapered wall. The top cap may further include an insertion portion for engagement within the dispensing opening. At least one sealing gasket is provided for sealing the closed dispensing opening. An attachment means is provided for fixing the insertion portion and cap to the top end. The attachment means may be an external thread on the insertion portion and a matching thread formed within the dispensing open on the inside wall. An insulator may be provided within the top cap.

The bottom cap portion of the contemplated container may also include an insertion portion for engagement within the open bottom end of the body. At least one sealing gasket is provided for closing and sealing the bottom opening, although two gaskets are preferred. An attachment means is provided for fixing the bottom cap to the sidewall. The attachment means may be in the form of an external thread on the insertion portion and a matching thread formed within the dispensing open on the inside wall. An insulator may be provided within the top cap.

Preferably the insertions portions of the top and bottom caps have dissimilar dimensions. Both caps may be formed to provide a stable base for the container, resulting in the container standing upright when resting on either the top cap or bottom cap. In addition, it is contemplated that the retained liquid or other material may be accessed from either end.

Other features of the present invention and combinations of features will become apparent from the detailed description to follow, taken in conjunction with the accompanying drawings.

### BRIEF DESCRIPTION OF THE DRAWINGS

For the purpose of illustrating the invention, the drawings show one or more forms that are presently preferred. It should be understood that the disclosure and claimed invention is not limited to the precise arrangements and instrumentalities shown in the drawings.

FIG. 1 is a isometric view of an embodiment of a container as contemplated by the present disclosure.

FIG. 2 is an exploded isometric view of the container embodiment of FIG. 1.

FIG. 3 is a cross section of the container embodiment of FIGS. 1 and 2.

FIG. 3A is an enlarged view of the top portion of the cross section of FIG. 3.

FIG. 3B is an enlarged view of the bottom portion of the cross section of FIG. 3.

FIG. 4 is an exploded view of the top cap portion of the container embodiment.

FIG. 5 is an alternate cross section of the top portion of the container embodiment.

FIG. 6 is an exploded view of the bottom cap of the container embodiment.

FIG. 7 is an enlarged cross section of the bottom cap portion of the container embodiment.

FIG. 8 is a cross section view of an alternate form of the container.

FIGS. 8A, 8B and 8C are enlarged cross sections of the top and bottom portions of the container form shown in FIG. 8.

FIG. 9 is a isometric view of a further alternate form of the container with a plug portion shown in an exploded position.

FIG. 10 is an exploded cross section view of the container form of FIG. 9.

FIG. 11 is an assembled cross section view of the container form of FIGS. 9 and 10.

### DETAILED DESCRIPTION

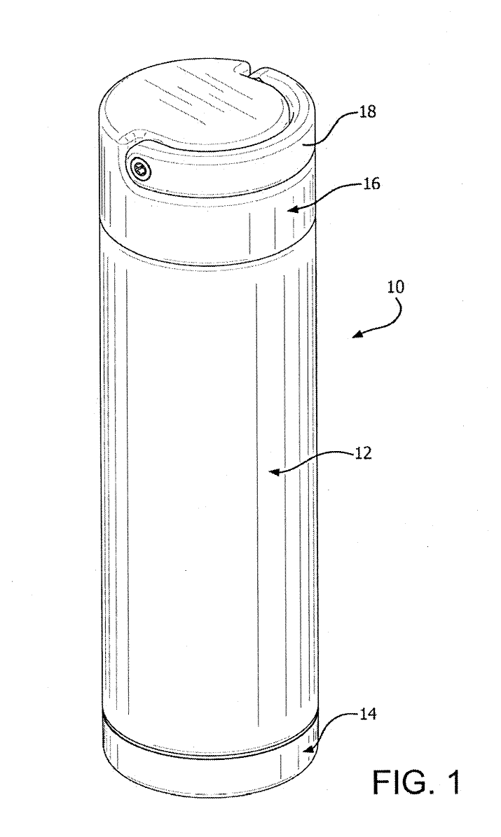

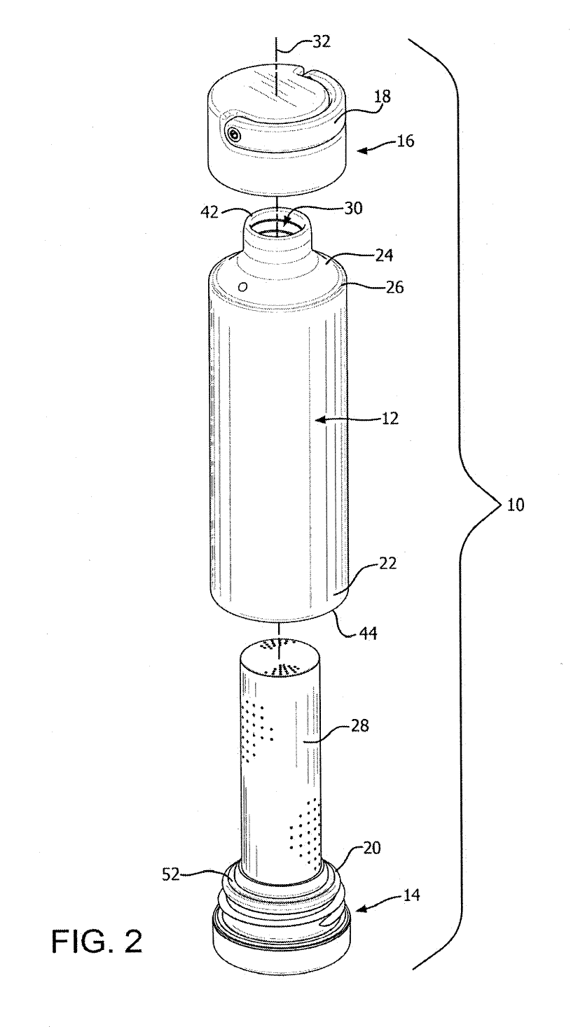

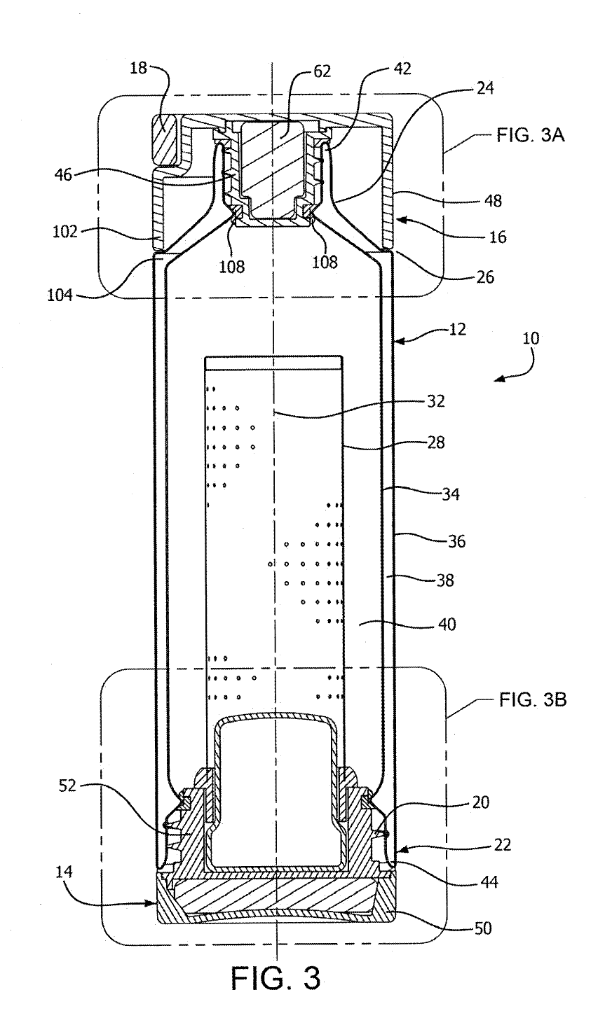

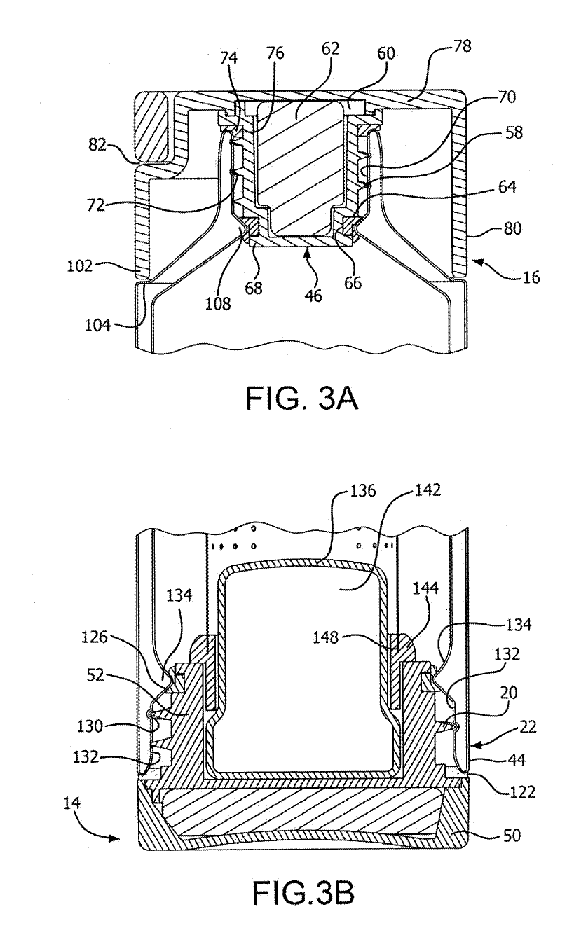

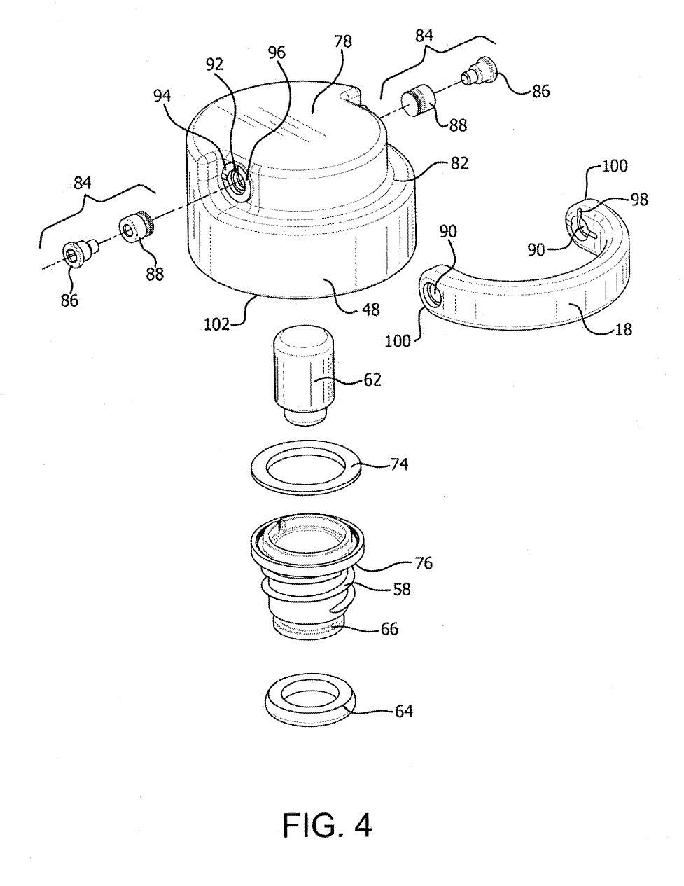

In the figures, where like numerals identify like elements, there is shown an embodiment of a container that is generally identified by the numeral 10. The container 10 as shown in FIG. 1 generally includes a cylindrical sidewall or body portion 12, a bottom cap 14 and a top cap 16. Preferably, the container body 12 is formed at least in part by a rigid material, with stainless steel being preferred. The top cap 16 includes a pivotable handle 18, illustrated in a nested or recessed position on the top cap 16. As shown in an exploded condition in FIG. 2, both the bottom cap 14 and top cap 16 are removable from the sidewall portion 12. The bottom cap 14 includes external threads 20 on an outside surface, which mate with corresponding internal threads (see FIG. 3) within an interior portion of the sidewall 12, adjacent to a first or bottom end 22 of the body sidewall 12. The top cap 16 is similarly secured to a neck portion 24 defined at the top end 26 of the sidewall 12. The bottom cap 14 is shown as supporting an infuser 28. The tapered neck 24 on the top end of the sidewall 12 defines a dispensing opening 30.

In FIG. 3, the container 10 of FIGS. 1 and 2 is shown in cross section in the assembled condition. In the drawings, the body 12 is formed as a cylinder about a central longitudinal axis 32. The sidewall 12 is shown as including an inside wall 34 and an outside wall 36, which are concentrically positioned about the axis 32 and spaced from one another. An inside surface of the inside wall 34 defines, along with the bottom cap 14 and top cap 16, a hollow interior 40, serving as a storage volume for the container 10. The inside wall 34 and outside wall 36 of the body 12 are secured to one another at both the rim 42 of the neck 24 and at a bottom edge 44 at the bottom end 22. The wall spacing defines a spaced volume 38 and preferably forms a sidewall insulation. The walls 34, 36 are preferably attached to one another to seal the internal volume. A vacuum is preferably provided within the spacing 38 upon securing of the walls together to assist in creating the insulating effect. An insulating foam or other material (not shown) may be included within the space between the inside and outside wall.

As illustrated in the cross sections of FIGS. 3 and 3A, the top cap 16 is attached to neck portion 24 of the body 12, closing the dispensing opening 30. The top cap 16 includes an insertion portion 46, which closes the dispensing opening 30, and an outer cup portion 48. As shown in FIGS. 3 and 3B, the bottom cap 14 includes a base member 50, an insertion member 52 and the infuser 28. The bottom cap 14 and top cap 16 combine with the sidewall 12 to create an interior storage volume 40 within the container 10.

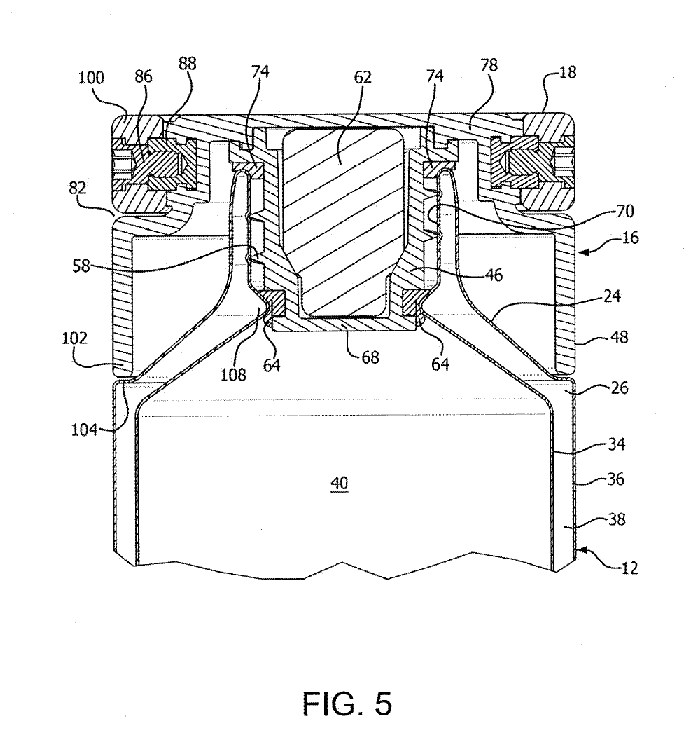

The constituent parts of the top cap 16 are illustrated in FIG. 4. The insertion portion 46 includes an external thread 58 and a hollow interior 60. An insulator 62 is a formed element that fits within the hollow 60 of the insertion portion 28. The insulator 62 is preferably made from a lightweight rigid material, such as a Styrofoam™ foam, an aerogel or the like. A first gasket 64 is retained within a groove 66 on the projected end 68 of the insertion portion 46. As shown in the cross sections of FIGS. 3 and 3A, the top end of the insertion portion 46 is attached to the underside of the top wall 78. An engagement groove is provided on the insertion member 46 that fits with a matching formation on the underside surface of the top wall 78. The two parts are welded or adhesively attached to one another, sealing the insulator 62.

As also shown in the cross-section views, the first gasket 64 seals with an annular inward projection 108 on the interior surface 70 of the neck portion 24. The external thread 58 engages with the internal thread 72 in the form of grooves within the internal surface 70 of the neck 24. A second gasket 74 is provided within a top groove 76 on the insertion portion 28. As shown in the cross section, the second gasket 74 engages the lip of the top rim 42. The first gasket 64 engages an inward annular projection 108 formed by the inside wall 34 at the base of the neck 24. The first gasket 64 and second gasket 74 combine to seal the dispensing opening 30 when the top cap 16 is engaged on the top end 26 of the body 12. The engagement of the threads 58, 72 retain the insertion portion 46 within the dispensing opening 30. The insertion portion 46 is attached to an interior surface of a top wall 78 of a cup portion 48. An outer cylindrical wall 80 depends from the top wall 78. The outer diameter of the wall 80 is shown as having the same dimension as the outside wall 36. The projected rim 102 of the wall 80 is positioned adjacent a shoulder surface 104 formed at the juncture of the cylindrical portion and the tapered neck 24.

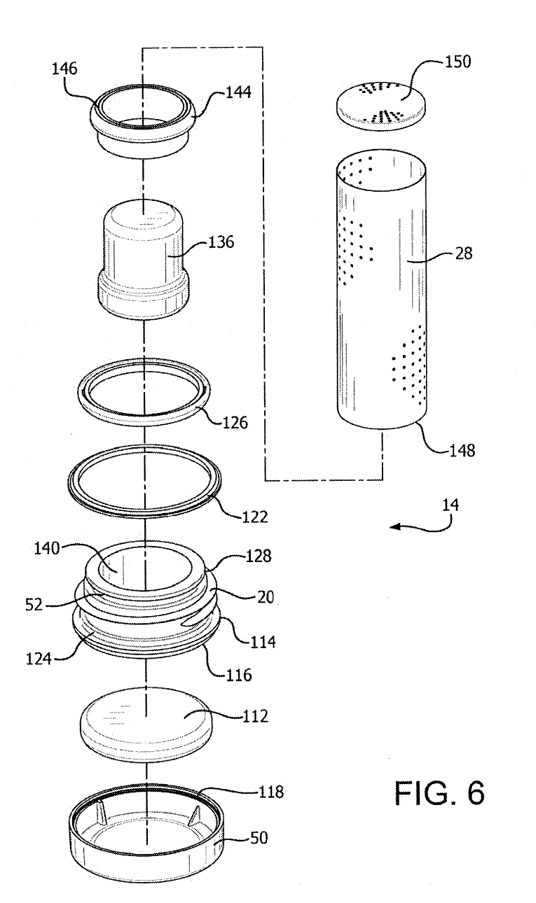

The handle portion 18 of the top cap 16 fits within a groove or recessed portion 82 formed at the transition of the top wall 78 and outside wall 80 of the cup portion 48. The dimensions of the handle 18 are selected to match the cylindrical profile of the top cap 16 and body 12 of the container 10. As more particularly shown in FIG. 5, the handle 18 is pivotably attached to the cup portion 48 by a retaining portion 84 formed from a retention pin 86 and a receptor sleeve 88. The pin 86 fits within a hole 90 in the wall of the handle 18. The receptor sleeve 88 is retained within a hole 92 in the outer wall 80 of the top cap 16. The retention pin 86 is attached to the receptor sleeve 88 by a snap fit assembly. The inside end of the receptor sleeve 88 is fit within the hole 92 in the top cap wall 80. The pin 86 retains the handle 18 secured to the top cap 16. The pin 86 is rotatable within the receptor sleeve 88. As such, the handle 18 may be pivoted from a retained position as shown in FIG. 1 to an upward or carrying position. Other structures for fixing the handle to the cap may be provided, such as a transverse pin member. In addition, the pins may be formed as part of the handle and the resilience of the handle material may serve to retain the handle ends engaged with the top cap during pivoting or carrying.

Two projecting nubs 94 are provided on a bearing surface 96 within the cap groove 82. Corresponding slots 98 are provided at strategic locations on the inside surface 100 of the ends of the handle 18. The combination of nubs 94 and slots 98 create pivot holding positions for the handle 18 relative to the cap 16, whereby the handle remains in the retained or recessed position (FIG. 1) or in an upright position. A small force is required to overcome the retention and shift the pivot of the handle between the two positions. Other shapes and forms for the detent structures may be provided, along with additional fixing positions for the handle.

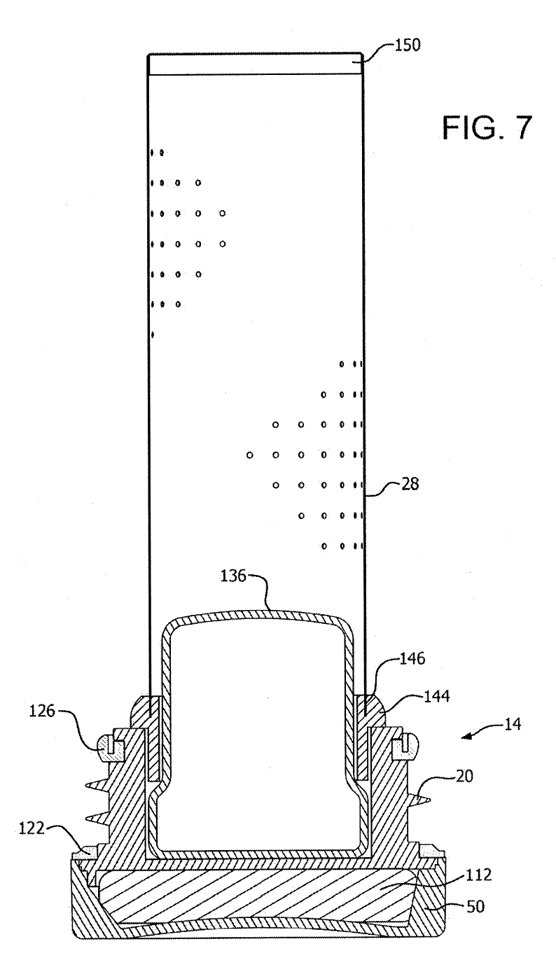

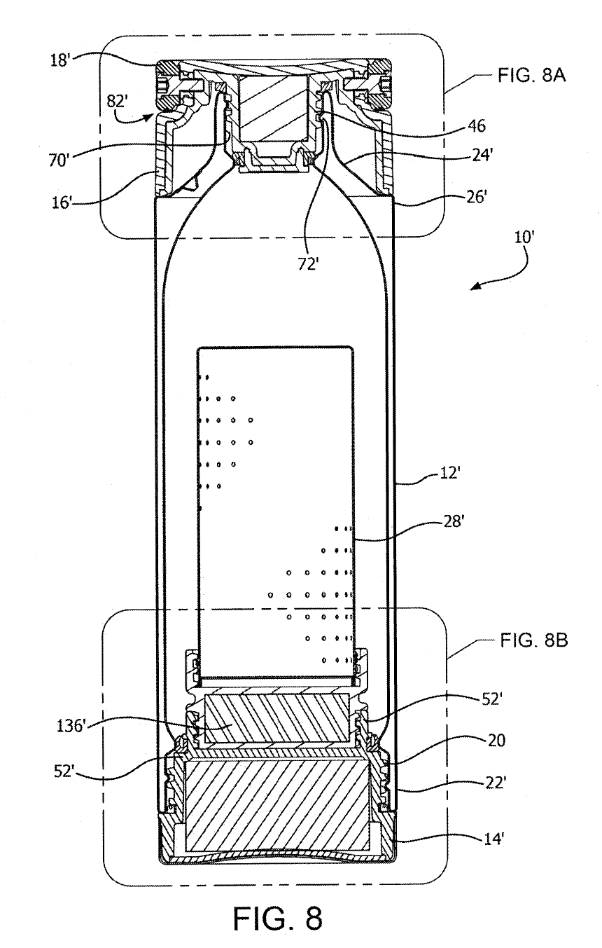

The constituent parts of the bottom cap assembly 14 are shown in FIGS. 6 and 7. A cup 110 provides a support base for the container 10 as a whole. An insulator 112 fits within the hollow of the cup 110. An insertion member 52 fits over the insulator 112. As more particularly shown in cross section FIG. 3B, the base 116 of the insertion element 114 is attached to the rim 118 of the cup 110. The attachment is created by ultrasonic welding, an adhesive or other suitable securing method. The base 116 of the insertion element 52 forms a continuous wall, which seals the insulator 112 within the cup 50. The insulator 112 is again formed from a lightweight rigid material. An external thread 120 is provided on the outside surface of the insertion element 114. A first gasket 122 is provided at the base 116 of the insertion element 52. The first gasket 122 is positioned on a shoulder 128 formed at the connection between the base 116 of the insertion element 52 and the rim 118 of the cup 50. A second gasket 126 fits within a groove 124 on the top end of the insertion element 52. Upon assembly, the external thread 20 engages with a matching thread 130 formed in the inside surface 132 on the inside wall 34, adjacent the bottom end 22 of the body 12. An inward annular projection 134 is formed in the inside wall 34, creating an engagement surface for the second gasket 126. A similar engagement is created by the first gasket 122 with the lip formed at the bottom end 22 of the body 12.

The bottom cap 14 also supports a temperature regulator 136 and the infuser tube 28. The temperature regulator 136 is positioned within a central hollow 140 of the insertion element 114. The regulator 136 includes a material 142 having the function of retaining an applied hot or cold condition. For example, the regulator 136 may be placed in a freezer and, when inserted into the container, serves to assist in maintaining the cool or cold temperature of the stored food or liquid within the container 10. Alternatively, the regulator 136 may be heated in a microwave or by other methods, to add heat to the stored food or liquid material. The material 142 within the regulator 136 is preferably a non-toxic gel material. The material 142 may be retained within a rigid casing, formed from low density polyethylene or the like.

A retainer gasket 144 surrounds the outside surface of the regulator 136 and engages with an inside surface of the hollow 140 of the insertion element 114. The retainer 144 includes a top groove 146 for receiving a bottom rim 148 of the infuser tube 28. The tube 28 is contemplated to retain materials that will add flavoring or the like to the liquid or foodstuff retained within the container 10. The tube may also retain additional ice for keeping the container contents cool or cold. The infuser tube 56 is contemplated to include a porous outer surface and is preferably formed from stainless steel. The size and shape of the tube may vary depending on the material to be retained. For example, the perforation sizing and the length of the tube may be different for loose tea as compared to retaining fruit pieces. As shown in FIG. 6, a removable top cap 150 is provided. The tube 28 retains the materials during dispensing. The rim 148 of the tube is secured within the slot or groove 146 of the retainer gasket 144. A thread or other surface may be provided to aid in securing the tube within the retainer 144. Similarly, the retainer 144 may include an engagement surface for securing the retainer within the hollow 140 of the insertion element 114 or for fixing the temperature regulator 136. Similarly, the regulator 136 may include a retention surface for securing the regulator within the hollow 140 of the insertion element 114. All gaskets may be formed from any desired flexible or resilient material, such as silicone rubber.

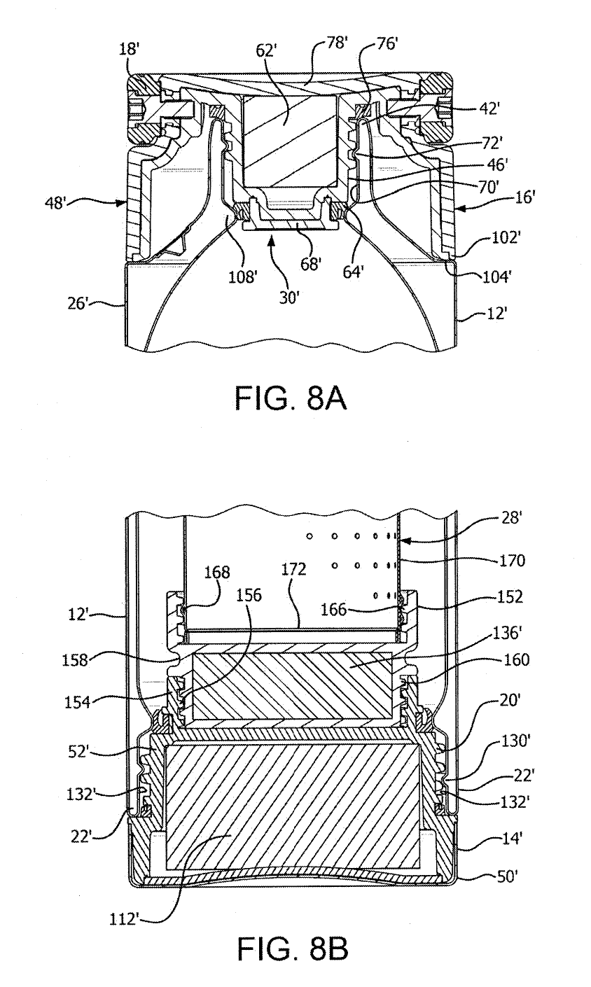

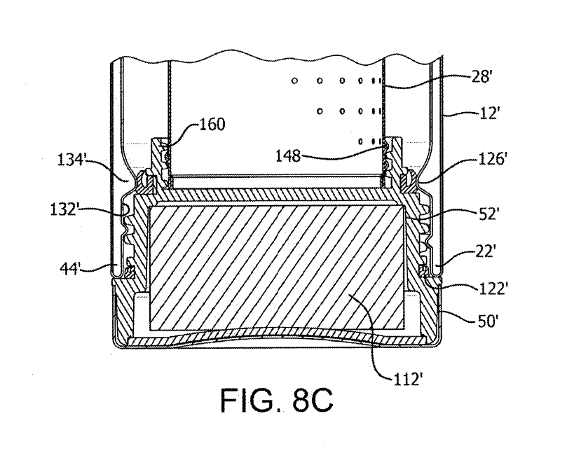

A further embodiment of double-wall, vacuum insulated container 10′ is illustrated in cross section in FIG. 8. The top cap 16′ is similar in form to that shown and described above. A handle 18′ is pivotally attached to a cup portion 48 and positioned within a recess or groove 82′. An insertion portion 46′ is provided within the cup 48′ and engages within a dispensing opening within a tapered portion 24′ of the top end 26 of the container body 12′. A base member or bottom cap 14′ is provided at the bottom end 22′ of the container body 12′. The base member 14′ includes an insertion portion 52′ having an external thread 20 for engagement within an internal thread 130′ on the inside surface 132 of the bottom end 22′ of the container body 12′. A retainer member 152 is fixed to the insertion portion 46′. The retainer 152 includes an internal chamber housing a temperature regulator 136′. The retainer 152 further supports an infuser tube 28′.

In the enlarged cross section of FIG. 8A, further details of the top cap 16′ become apparent. The insertion member projection 46′ includes two gaskets 64′ and 76′ that engage separate surfaces 108′ and 42′ adjacent the dispensing opening 30′ on the top of the container body 12 the top end 68′ of the projection 46′ is separately attached to the main part of the projection. The top end 68′ assists in retaining the top gasket 64′. The top gasket engages the annular inner projection 108′ formed on the inside surface 70′ of the dispensing opening 30′. The top wall 78′ is also a separate portion of the cup 48′. The cup 48′ and insertion member 46′ upon assembly retain an insulator 62′. The second gasket 76′ engages with the lip or rim 42′ of the container body 12′, forming the secondary seal for the top cap 12′. The outer rim 102′ of the cup 48′ aligns with a shoulder 104′ formed at the top end 26′ of the container body 12′.

In the enlarged cross section of FIG. 8B, there is shown further detail of the bottom cap 14′ and the provided retainer element 152. The bottom cap 14′ includes a base member 50′ having a hollow interior that is filled with an insulator 112′. An insertion portion 52′ projects from the base 50′. An annular outer surface of the insertion portion 52′ includes an external thread 20′ that engages with an inside surface 132′ of the bottom end 22′ of the container body 12′. An open cup 154 is formed at the top end of the insertion portion 52′. An internal thread 156 is provided within the interior of the cup 154. A base portion 158 of the retainer element 152 includes an external thread 160 that engages with the internal thread 156 of the cup 154. The base portion 158 houses a temperature regulator 136′. A retainer cup 162 projects from a top wall 164 of the base 158 of the retainer 152. The retainer cup 162 includes an internal cup thread 166. An infuser tube 28′ has an external tube thread 168 on its outer surface 170. The tube thread 168 engages with the internal cup thread 166 to secure the infuser 28′ to the retainer 152. The infuser tube 28′ is shown as having a bottom wall 172.

In the cross section of FIG. 8C, the retainer portion 152 has been removed from the assembly. The internal thread 156 of the open cup 154 of the insertion element 52′ engages the external thread 168 of the infuser tube 28′ such that the infuser tube is secured to the base 50′ of the bottom cap 14′. Other structures may also be secured to the cap structure by engagement with the threads 156 as shown, or by the use of other attachment means. Further, the retainer 152, and its associated temperature retainer, may be attached to the cap 14′ without also attaching the infuser to the retainer 152.

The bottom cap includes two gaskets 122′ and 126′. The first gasket 122′ is provided at the intersection between the base 50′ and the insertion portion 52′. The first gasket 122′ seals the bottom cap 14′ to the bottom lip or rim 44′ of the container body 12′. The second gasket 126′ is provided on the outside wall of the insertion portion 52′ and engages with an annular inner projection 134′ on the inside surface 132′ of the sidewall of the container body 12′. Additional, sealing surfaces may be provided on the insert portion 52′, the retainer 152 or the infuser tube 28′.

The bottom rim 44′ of the sidewall of the container body 12′ is provided with a curved (non-sharp) surface profile. In addition, this internal threads 130′ are preferably spaced inwardly from the rim 44′. It is contemplated that the bottom opening at the bottom end 22′ of the container body 12′ also forms a dispensing opening, upon removal of the cap 14′. This would include the drinking of liquids from the bottom opening.

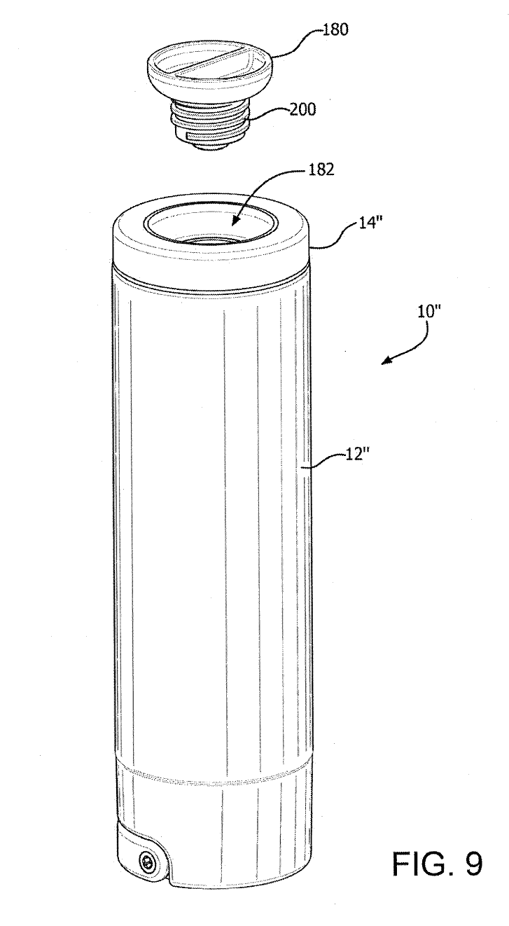

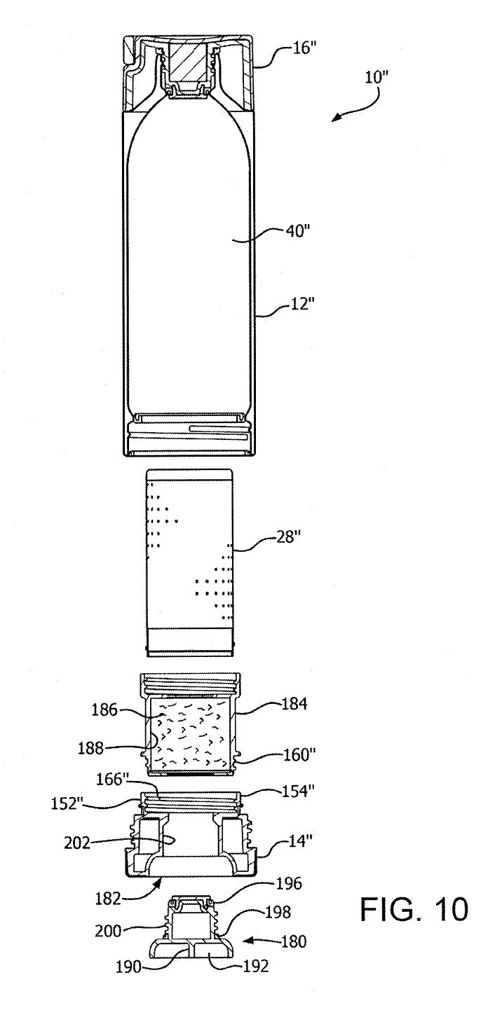

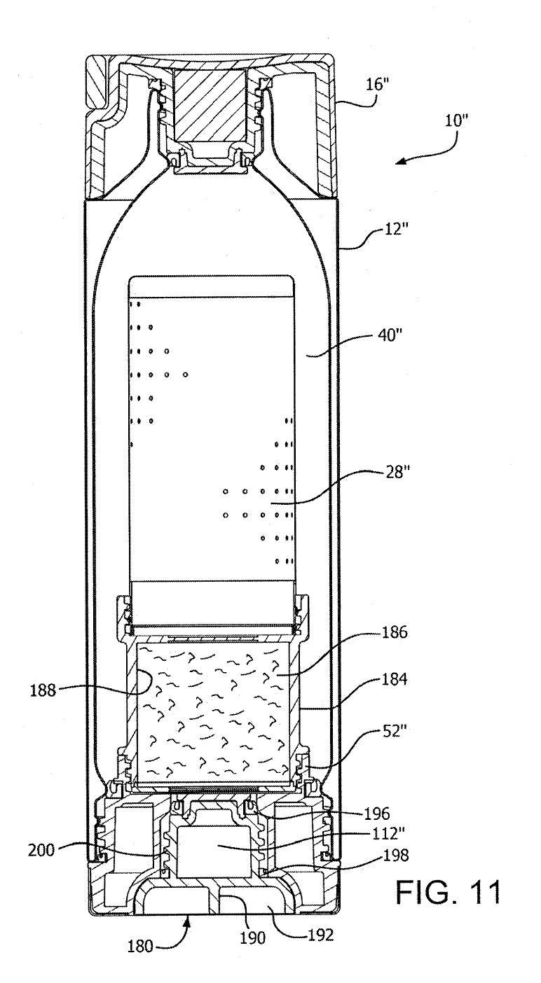

In FIG. 9, there is shown a further container form 10″. The container 10″ is in an inverted position, with the bottom cap 14″ positioned at the top. The top cap 14″ includes a removable sealing plug 180, which is shown separated from an opening 182 in the cap 14″. In the exploded view of FIG. 10, it can be seen that the plug 180 is formed to engage with the opening 182 of the bottom cap 14″. The opening 182 is contemplated to extend through the central portion of the bottom cap 14″, providing access to the internal storage volume 40″ of the container body 12″. A retainer is provided in the form of a filter member 184. The filter member 184 is positioned between the cap 14″ and an infuser tube 28″. As shown in the cross section of FIG. 11, the plug 180 engages within and seals the opening. The filter member 184 engages with the insertion portion 52″ of the bottom cap 14″. This engagement of the filter member 184 with the bottom cap 14″ is contemplated to be similar to the engagement of the retainer 152 as shown in FIG. 8. Similarly, the infuser tube 28″ is axially positioned with and secured to the filter member 184, similar to engagement of the infuser tube 28′ with the retainer form shown in FIG. 8.

The filter member 184 includes a filter medium 186 within an internal chamber 188. Fluid directed into the opening 182 passes through the filter 184 and into the infuser tube 28″. Because the infuser tube 28″ is porous, the filtered fluid can then pass into the interior volume 40″ of the container body 12″. The tube 28″ may be left out of the assembly, such that the filtered fluid passes directly into the interior 40″ of the body 12″. The cap 14″ may be separated from the filter 184, if desired during transport of the container 10″ or for cleaning. A retainer similar to that shown in FIG. 8 may be attached to the cap 14″ (or the filter) for temperature maintenance of the stored material.

As shown, a transverse flange 190 positioned in a recess 192 on the exposed end 194 of the plug 180. The flange 190 assists in rotating the plug 180 during insertion into the opening 182. The plug 180 includes an internal insulator 112″ and first and second sealing gaskets 196 and 198. An external thread 200 is formed on the plug 180 and engages with an internal surface 202 of the opening 182. The filter member 184 includes an external engagement thread 160″ for securing the filter 184 to the projected end 154″ of the cap 14″. An internal thread 166″ is provided on the insertion end 152″ of the filter member 184 for engagement with the infuser tube 28″.

In the forms of the container as illustrated, the engagement of the top cap and bottom cap with the container body are similar, thus permitting drinking and dispensing of product from either end of the storage volume. The rims of the respective openings are rounded for comfort. It is preferred that the container forms include two different size openings at the top and bottom ends. However, it is possible that the openings be of similar dimension, making the top cap and bottom cap interchangeable on the container body. The relatively larger diameter of the bottom opening provides for relatively easy cleaning of the interior of the container body.

In the forms shown, the caps and plug include two gaskets to form an internal seal at two locations that are axially spaced from one another. This combination seal is contemplated to increase seal security, reducing the likelihood of leaks. Further, because of temperature variations, the materials of the caps, plug and container body may be subjected to dimensional changes. The multiple seal locations add to the seal security in multiple operational conditions. The addition of insulating materials within the caps and plug assists in temperature maintenance, since heat transfer in vacuum insulated containers is often greater through the cap portions.

Although stainless steel is the preferred material for the body of the container, other metallic materials may be used, including aluminum. A rigid plastic material may also be used for one or both of the wall portions that create the container body. An inert coating may be applied on the inside surface of the inside wall. A coating, paint, indicia or graphics may also be applied to (or formed within) the surfaces of the body or caps. The preferred method of forming the steel parts is hydroforming. The plastic parts may be formed by injection molding, blow molding, extrusion or other processes.

The cup portion of the top cap and the base cup of the bottom cap may be formed from stainless steel or the like so as to create a match with the material of the body portion of the container. Different materials may be selected as desired. An outer cladding material may be applied to an underlying cap structure formed from polypropylene or other plastic. The cladding may be press fit onto the underlying cap structure, with retention elements fixing the portions together. The insertion portions for the caps are preferably made from polypropylene, with other plastics being possible. It is possible for the outer portion of the cup or the base member to be detachable from the inner assemblies of the top cap and bottom cap. This outer cup may the serve as a retaining vessel for holding a portion of the contents of the container, while the remaining structures seal the container openings. The handle is preferably made from a glass filled nylon material. A stainless-steel cladding may be applied over the nylon structure and fixed by an adhesive, press fit or other attachment method.

The present invention has been described and illustrated with respect to one or more exemplary embodiments. It should be understood by those skilled in the art from the foregoing that various other changes, omissions and additions may be made therein, without departing from the spirit and scope of the present invention, with the scope of the invention being described by the foregoing claims.

1. A container comprising
a body portion having
a sidewall made of stainless steel, the sidewall formed in a cylinder about a central longitudinal axis, the sidewall having
an inside wall,
an outside wall,
a first open end, and
a second open end,
an inside surface of the inside wall defining an hollow interior for the container,
the inside wall and the outside wall of the sidewall being spaced from one another to define a spaced volume, the spaced volume being vacuum sealed to form a sidewall insulation;
a bottom cap removably attachable to the first end of the sidewall for closing the first end; and
a top cap removably attachable to the second end of the sidewall for closing the second end,
wherein the bottom cap and top cap combine with the sidewall to close the hollow interior and to create an interior storage volume within the container, and
wherein either the top cap or bottom cap may be selectively removed for dispensing material from within the storage volume.

2. A container comprising
a sidewall formed about a central axis, the sidewall having
an inside wall,
an outside wall,
a first open end, and
a tapered second open end,
an inside surface of the inside wall defining an hollow interior for the container,
the second end forming a dispensing opening,
at least a portion of the inside wall and the outside wall being spaced from one another to define a spaced volume, the spaced volume forming a sidewall insulation;
a bottom cap removably attachable to the first end of the sidewall for closing the first end, the bottom cap forming a base for the container; and
a top cap removably attachable to the tapered second end of the sidewall for closing the second end,
the top cap and bottom cap each having first and second gasket members, the first and second gasket members, when attached to the respective first and second open ends of the sidewall, engaging on separate locations of an inside surface of the inside wall of the sidewall, and
wherein the bottom cap and top cap combine with the sidewall to close the hollow interior and to create an interior storage volume within the container.

3. A container as in claim 2, wherein at least a portion of the sidewall is formed by a metallic material.

4. A container as in claim 3, wherein at least one wall of the sidewall is formed by a stainless-steel material.

5. A container as in claim 2, wherein the sidewall is formed in a cylinder about the central axis.

6. A container as in claim 2, wherein the inside wall and the outside wall are affixed to one another adjacent both the first end and the second end.

7. A container as in claim 2, wherein the spaced volume between the inside wall and the outside wall is vacuum sealed.

8. A container as in claim 2, further comprising a retainer member removably attached to the bottom cap, the retainer securing a tubular member to the bottom cap and positioning the tubular member within the interior storage volume of the container upon attachment of the bottom cap to the bottom end of the container body.

9. A container as in claim 8 wherein the retainer member has a resilient structure and frictionally secures the tubular member within an opening in the bottom cap.

10. A container as in claim 8 wherein the retainer member may be selectively secured to the bottom cap by means of an attachment structure.

11. A container as in claim 10 wherein the attachment structure are matching threads in the retainer and the bottom cap.

12. A container as in claim 10 wherein the tubular member is selectively secured to the retainer structure or the bottom cap by a tube attachment structure.

13. A container as in claim 8 wherein the tubular member serves to retain material that infuses into the material retained within the interior storage volume.

14. A container as in claim 2 wherein the bottom cap includes a temperature regulator for assisting in maintaining the temperature of material retained within the interior storage volume.

15. A container as in claim 8 wherein the retainer further comprises a filter media and the bottom cap comprises a fill opening, the fill opening and retainer creating a fluid passage through the filter media and into the storage volume of the container.

16. A container as in claim 15 further comprising a removable plug dimensionally formed to selectively close the fill opening in the bottom cap.

17. A container comprising
a body portion having
a sidewall made of stainless steel, the sidewall formed in a cylinder about a central longitudinal axis, the sidewall having
an inside wall,
an outside wall,
a first open end, and
a second open end,
an inside surface of the inside wall defining a hollow interior for the container,
the inside wall and the outside wall of the sidewall being spaced from one another to define a spaced volume, the spaced volume being vacuum sealed to form a sidewall insulation;
a bottom cap removably attachable to the first end of the sidewall for closing the first end;
a top cap removably attachable to the second end of the sidewall for closing the second end, the bottom cap and top cap combine with the sidewall to close the hollow interior and to create an interior storage volume within the container, and wherein either the top cap or bottom cap may be selectively removed for dispensing material from within the storage volume; and
a retainer member selectively and removably attached to the bottom cap,
a tubular member selectively and removably attached to the bottom cap or the retainer member such that the tubular member is positioned within the interior storage volume of the container.

18. A container as in claim 17 wherein the tubular member having a porous outer surface, the tubular member formed to retain a material that interacts with a liquid material retained within the interior storage volume.

19. A container as in claim 17 further comprising a temperature regulator for assisting in maintaining the temperature of material retained within the interior storage volume.

20. A container as in claim 17 further comprising
a filter media within the retainer,
a fill opening within the bottom cap, the fill opening and retainer creating a fluid passage through the filter media and into the storage volume of the container, and
a removable plug dimensionally formed to selectively close and be retained in the fill opening.

21. A container for storing a beverage comprising:
an insulated sidewall defining an interior storage volume, the side wall having a top opening and a bottom opening,
a removable top formed to be attached to the top opening, and
a removable bottom formed to be attached to the bottom opening.

22. A container for storing a beverage within an interior storage volume comprising:
a body portion having an insulated sidewall,
a top removably attached to the sidewall at a top opening, and
a bottom removably attached to the sidewall at a bottom opening.

23. A container as in claim 2, further comprising an insulation material provided within the spaced volume between the inside wall and the outside wall of the sidewall.

24. A container as in claim 23, wherein the insulation material is an insulating foam.
